(19) United States
(12) Patent Application Publication
(10) Pub. No.: US 2025/0285566 A1
(43) Pub. Date: Sep. 11, 2025

(54) CHANGING TINTING LEVELS OF ONE OR MORE TINTING LAYERS

(71) Applicant: Apple Inc., Cupertino, CA (US)

(72) Inventors: Ioana NEGOITA, Sunnyvale, CA (US); Trent A. GREENE, Santa Clara, CA (US); Brian W. TEMPLE, Santa Clara, CA (US); Ian PERRY, San Jose, CA (US); Finnegan N. SINCLAIR, Seattle, WA (US)

(21) Appl. No.: 19/052,137

(22) Filed: Feb. 12, 2025

Related U.S. Application Data
(60) Provisional application No. 63/561,489, filed on Mar. 5, 2024.

(51) Int. Cl. G09G 3/00

(52) U.S. Cl. CPC G09G 3/003; G09G 2320/0626; G09G 2320/0686; G09G 2354/00; G09G 2360/144

(57) ABSTRACT

This relates generally to systems and methods for changing tinting levels of one or more lenses or displays, and more particularly to changing tinting levels of one or more lenses or displays of an electronic device in response to environmental stimuli. In some examples, an electronic device applies a first tinting level to the one or more lenses or displays (e.g., a dedicated layer of the display or a discrete layer that is separate from a display to adjust opacity). In some examples, while applying the first tinting level to the one or more lenses or displays, the electronic device determines that the one or more criteria are satisfied. In some examples, in response to determining that the one or more criteria are satisfied, the electronic device applies a second tinting level, different than the first tinting level to the one or more lenses or displays.

### CROSS-REFERENCE TO RELATED APPLICATIONS

This application claims the benefit of U.S. Provisional Application No. 63/561,489, filed Mar. 5, 2024, the entire disclosure of which is herein incorporated by reference for all purposes.

### FIELD OF THE DISCLOSURE

This relates generally to systems and methods of changing tinting levels of one or more displays, and more particularly to changing tinting levels of one or more displays of an electronic device in response to an environmental stimulus.

### BACKGROUND OF THE DISCLOSURE

Some computer graphical environments provide two-dimensional and/or three-dimensional environments where at least some objects displayed for a user's viewing are virtual and generated by a computer. Users of head mounted displays (HMDs) may have difficulty seeing the physical environment in response to environmental stimuli while wearing the HMD.

### SUMMARY OF THE DISCLOSURE

This relates generally to systems and methods for changing tinting levels of one or more lenses or displays, and more particularly to changing tinting levels of one or more lenses or displays of an electronic device in response to environmental stimuli. In some examples, an electronic device (e.g., an HMD) applies a first tinting level to the one or more lenses or displays (e.g., a dedicated layer of the display or a discrete layer that is separate from a display to adjust opacity). In some examples, while applying the first tinting level to the one or more lenses or displays, the electronic device determines that the one or more criteria are satisfied. In some examples, in response to determining that the one or more criteria are satisfied, the electronic device applies a second tinting level, different than the first tinting level to the one or more lenses or displays. For example, in response to determining a change in body pose because of a change in environment (e.g., squinting because the ambient light is brighter), the electronic device applies the second tinting level. Changing the tinting level in response to detecting a change in body pose because of a change in environment allows an improved user experience by adjusting the electronic device to the ambient conditions without requiring the user to manually the tinting level of the lenses or displays (e.g., changing the tinting level when the user indicates a difficulty seeing in response to the amount of light in the environment).

The full descriptions of these examples are provided in the Drawings and the Detailed Description, and it is understood that this Summary does not limit the scope of the disclosure in any way.

### BRIEF DESCRIPTION OF THE DRAWINGS

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3I illustrate examples of an electronic device presenting content differently and changing tinting levels of displays once one or more criteria are satisfied according to some examples of the disclosure.

FIG. 4 illustrates a flow diagram illustrating an example process for an electronic device changing tinting levels of displays and presenting content as a result of satisfying one or more criteria according to some examples of the disclosure.

### DETAILED DESCRIPTION

This relates generally to systems and methods for changing tinting levels of one or more lenses or displays, and more particularly to changing tinting levels of one or more lenses or displays of an electronic device in response to environmental stimuli. In some examples, an electronic device (e.g., an HMD) applies a first tinting level to the one or more lenses or displays (e.g., a dedicated layer of the display or a discrete layer that is separate from a display to adjust opacity). In some examples, while applying the first tinting level to the one or more lenses or displays, the electronic device determines that the one or more criteria are satisfied. In some examples, in response to determining that the one or more criteria are satisfied, the electronic device applies a second tinting level, different than the first tinting level to the one or more lenses or displays. For example, in response to determining a change in body pose because of a change in environment (e.g., squinting because the ambient light is brighter), the electronic device applies the second tinting level. Changing the tinting level in response to detecting a change in body pose because of a change in environment allows an improved user experience by adjusting the electronic device to the ambient conditions without requiring the user to manually the tinting level of the lenses or displays (e.g., changing the tinting level when the user indicates a difficulty seeing in response to the amount of light in the environment).

In some examples, presenting the extended reality environment with an electronic device includes presenting pass-through video of the physical environment of the electronic device. As described herein, for example, presenting pass-through video can include displaying virtual or video passthrough in which the electronic device uses one or more displays to display images of the physical environment. In other examples, presenting the extended reality environment with an electronic device includes presenting true or real optical see-through in which portions of the physical environment are visible to the user through a transparent portion of the display. In some examples, methods and examples described herein can be applied to electronic devices with no displays. For example, methods and examples described herein can be applied to electronic devices with lenses without displays. As described herein, reducing the level of tint of the display enables improved viewing of the physical environment through the transparent portion of the display, whereas increasing the level of tint of the display enables improved presentation of some virtual content (e.g., obstructing some or all of the physical environment). Additionally, increasing the level of tinting in response to a change in ambient light provides protection against harsh sources of light (e.g., the sun), as described herein.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

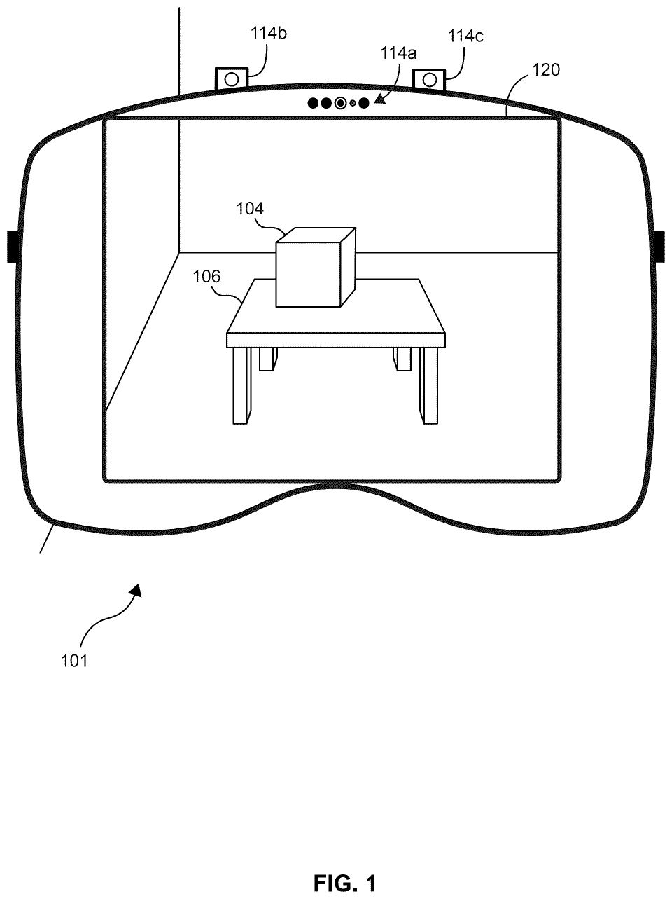

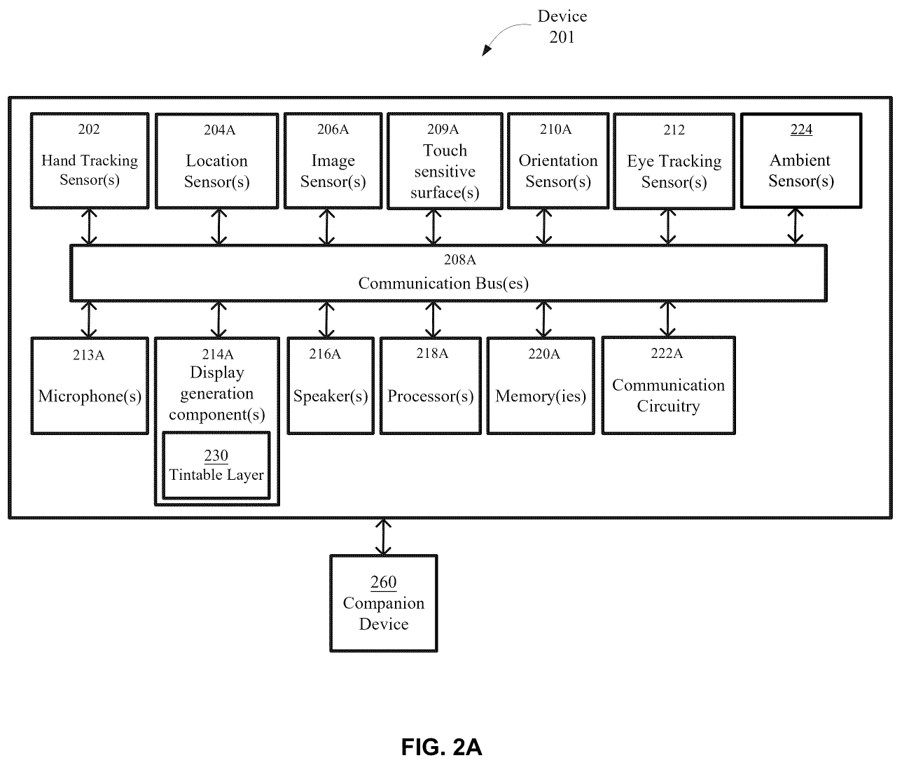

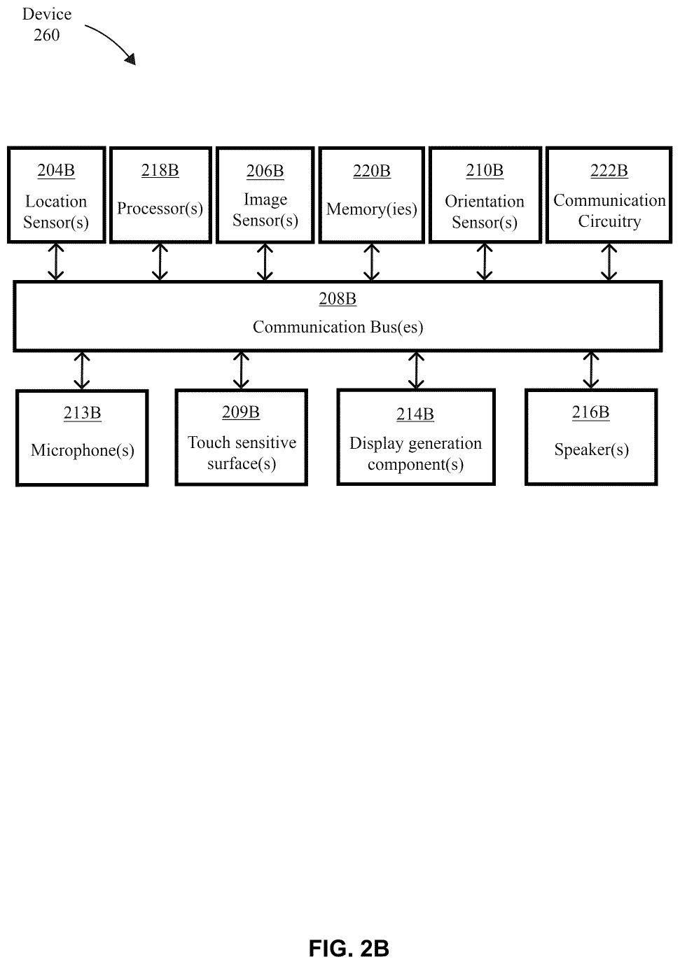

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120a to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120a has a field of view visible to the user (e.g., that may or may not correspond to a field of view of external image sensors 114b and 114c). Because display 120a is optionally part of a head-mounted device, the field of view of display 120a is optionally the same as or similar to the field of view of the user's eyes. In other examples, the field of view of display 120a may be smaller than the field of view of the user's eyes. In some examples, electronic device 101 may be an optical see-through device in which display 120a is a transparent or translucent display through which portions of the physical environment may be directly viewed. In some examples, display 120a may be included within a transparent lens and may overlap all or only a portion of the transparent lens. In other examples, electronic device may be a video-passthrough device in which display 120a is an opaque display configured to display images of the physical environment captured by external image sensors 114b and 114c. While a single display 120a is shown, it should be appreciated that display 120a may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120a of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, the electronic device 101 may be configured to communicate with a second electronic device, such as a companion device. For example, as illustrated in FIG. 1, the electronic device 101 may be in communication with electronic device 160. In some examples, the electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned (e.g., mounted) on a head of a user and the electronic device 160 may be positioned near electronic device 101, such as in a hand 103 of the user (e.g., the hand 103 is holding of the electronic device 160), and the electronic device 101 and the electronic device 160 are associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120a in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

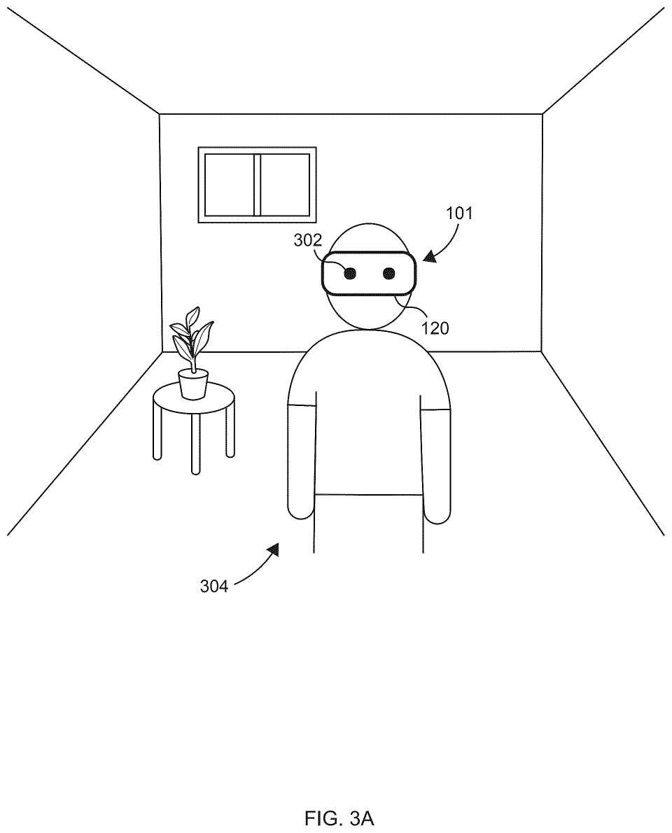

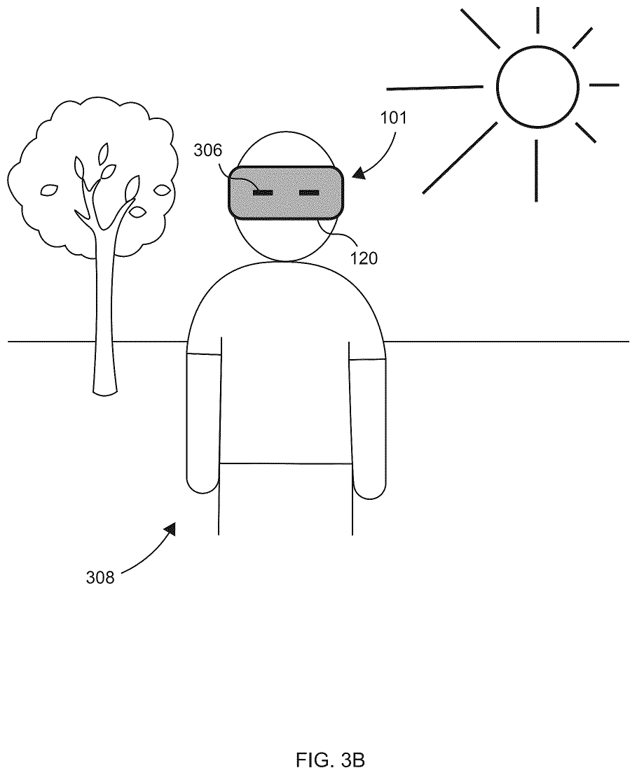

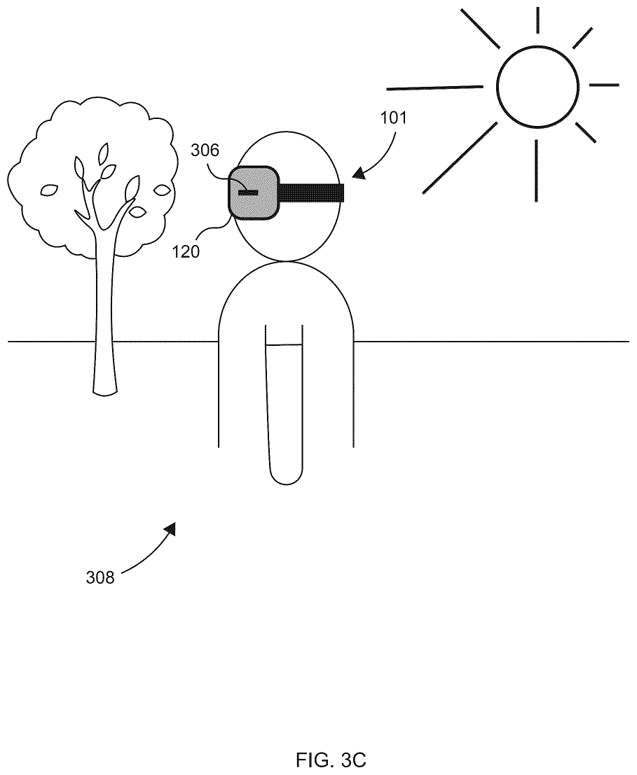

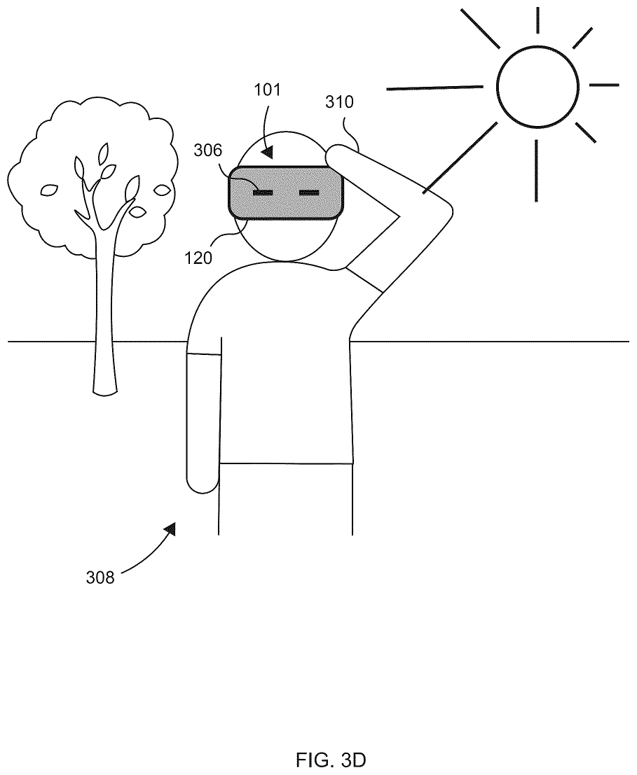

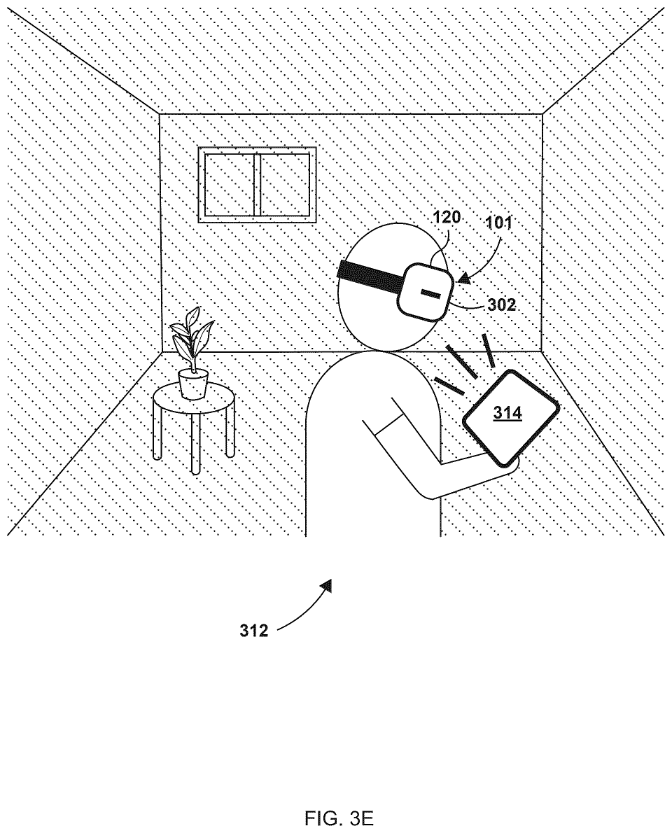

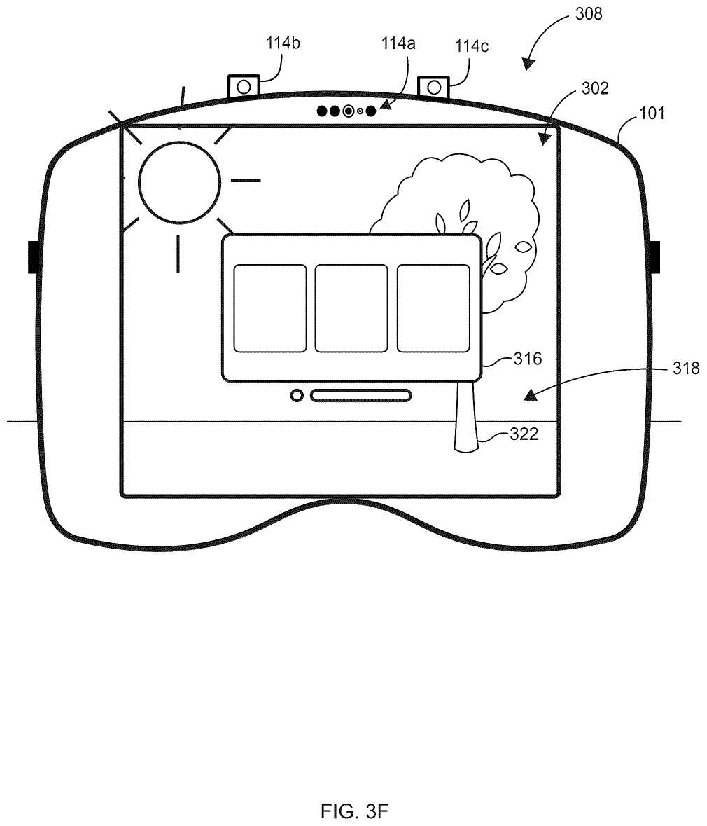

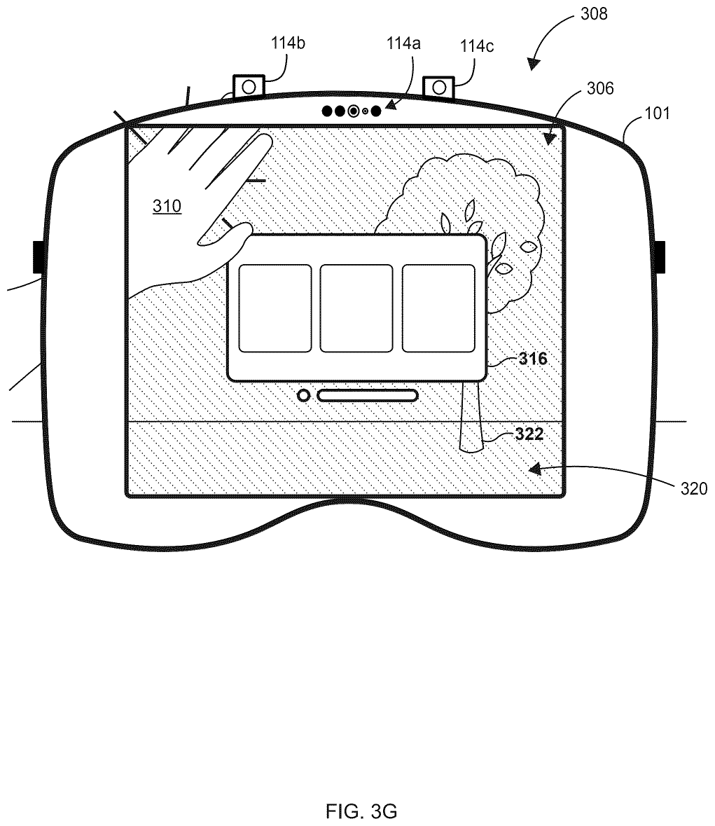

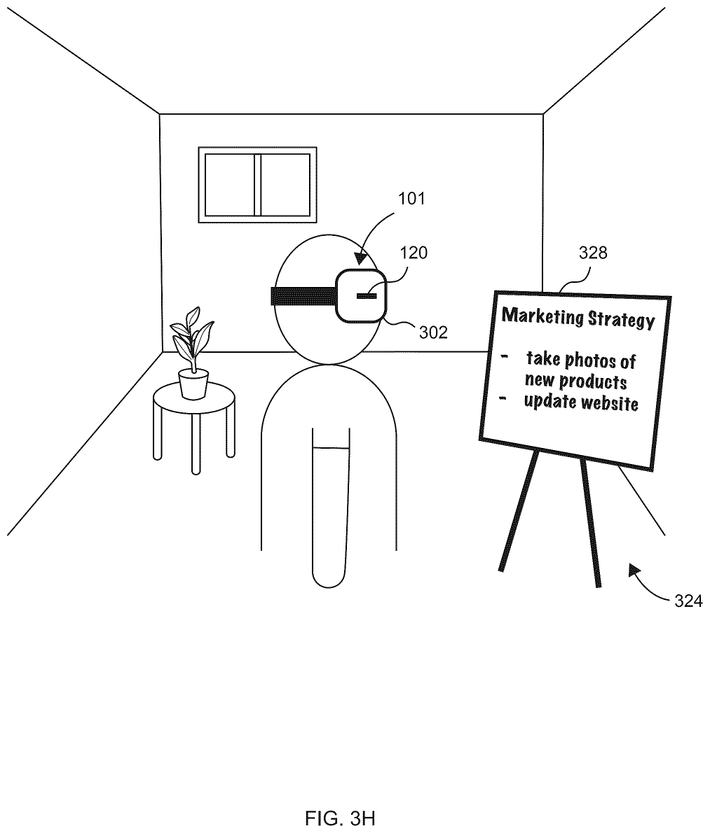

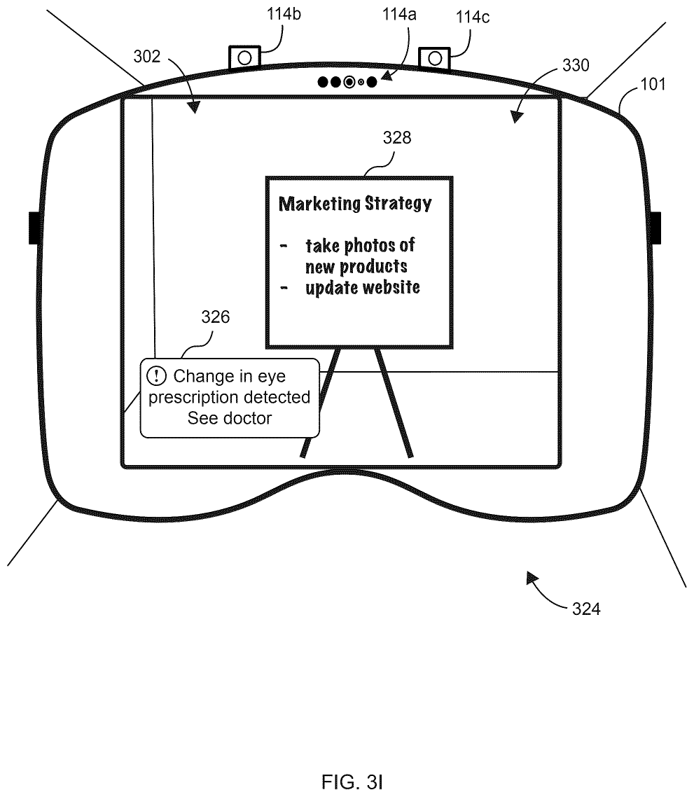

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260). In some examples, the display generation component(s) 214A includes one or more tinting layers, as described in further detail in FIGS. 3A-3I. In some examples, the tinting layers are integrated into display generation component(s) 214A. In some examples, the tinting layers are separate layers in the display generation component(s) 214A. For example, and as shown in FIG. 2A, the display generation component(s) 214A includes a tintable layer 230. In some examples, the electronic device 201 may only include a tintable layer 230 without including a display generation component(s) 214 (with one or more display functionalities described herein optionally available on a display of electronic device 260).

Although the electronic device is primarily described as a display having a tintable layer, the tinting functionality of the examples described herein may be implemented using an independent tintable layer without a display, a tintable layer with a display, a tintable lens, etc.

Electronic devices 201 and 260 optionally includes image sensor(s) 206A and 206B, respectively. Image sensors(s) 206A, 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A, 206B also optionally include one or more cameras configured to capture movement of physical objects in the real-world environment. Image sensor(s) 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, image sensor(s) 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses image sensor(s) 206A, 206B to detect the position and orientation of electronic device 201, 260 and/or display generation component(s) 214A, 214B in the real-world environment. For example, electronic device 201, 260 uses image sensor(s) 206A, 206B to track the position and orientation of display generation component(s) 214A, 214B relative to one or more fixed objects in the real-world environment.

In some examples, electronic devices 201 and 260 include microphone(s) 213A and 213B, respectively, or other audio sensors. Electronic device 201, 260 optionally uses microphone(s) 213A, 213B to detect sound from the user and/or the real-world environment of the user. In some examples, microphone(s) 213A, 213B includes an array of microphones (a plurality of microphones) that optionally operate in tandem, such as to identify ambient noise or to locate the source of sound in space of the real-world environment.

Electronic devices 201 and 260 include location sensor(s) 204A and 204B, respectively, for detecting a location of electronic device 201A and/or display generation component(s) 214A and a location of electronic device 260 and/or display generation component(s) 214B, respectively. For example, location sensor(s) 204A, 204B can include a global positioning system (GPS) receiver that receives data from one or more satellites and allows electronic device 201, 260 to determine the device's absolute position in the physical world.

Electronic devices 201 and 260 include orientation sensor(s) 210A and 210B, respectively, for detecting orientation and/or movement of electronic device 201 and/or display generation component(s) 214A and orientation and/or movement of electronic device 260 and/or display generation component(s) 214B, respectively. For example, electronic device 201, 260 uses orientation sensor(s) 210A, 210B to track changes in the position and/or orientation of electronic device 201, 260 and/or display generation component(s) 214A, 214B, such as with respect to physical objects in the real-world environment. Orientation sensor(s) 210A, 210B optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A. In some examples, electronic device 201 alternatively does not include hand tracking sensor(s) 202 and/or eye tracking sensor(s) 212. In some such examples, the display generation component(s) 214A may be utilized by the electronic device 260 to provide an extended reality environment and utilize input and other data gathered via the other sensor(s) (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the processor(s) 218B of the electronic device 260. Additionally or alternatively, electronic device 201 optionally does not include other components shown in FIG. 2B, such as location sensors 204B, image sensors 206B, and/or touch-sensitive surfaces 209B, etc. In some such examples, the display generation component(s) 214A may be utilized by the electronic device 260 to provide an extended reality environment and the electronic device 260 may utilize input and other data gathered via the one or more motion and/or orientation sensors 210A (and/or one or more microphones 213A) of the electronic device 201 as input.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 includes ambient sensor(s) 224 for detecting ambient environmental conditions in the real-world environment. In some examples, the electronic device 201 includes ambient light sensors to detect the amount of ambient light present. For example, ambient light sensors include photodiodes, photonic ICs, and/or phototransistors. In some examples, the ambient sensor(s) 224 are implemented together with the image sensor(s) 206.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards an electronic device (e.g., corresponding to electronic device 201 and/or electronic device 101) that includes one or more tintable layers such as one or more tintable lenses or one or more tintable displays. In some examples, an electronic device applies a first tint to the display before the one or more criteria satisfied. In some examples, a user may want a darker tint on the display (e.g., the second tint) when the physical environment has brighter ambient light. For example, in response to a change in environment including a change in ambient light, the user reduces the amount of light incident on their eyes (e.g., by squinting, turning their head, or covering the source of light with an object such as a hand, all of which satisfies the one or more criteria). In response to detecting the change in body pose, the electronic device applies the second tinting level to the one or more displays. The electronic device may use the one or more criteria described below to determine when to change the tint from the first tint to the second tint, as discussed with reference to FIGS. 3A-3I.

In some examples, the electronic device may receive an indication from one or more different electronic devices indicating that the user has a change in a body pose corresponding to reducing an amount of light incident on the user's eyes. For example, the one or more electronic devices include microphones, mobile phones, and/or smart watches. In some examples, the electronic device uses one or more sensors in communication with the electronic device (e.g., an inertial measurement unit (IMU) sensor) to determine if the user has a change in body pose.

The techniques described herein provide for an improved user experience. For example, the methods and systems described herein provide seamless transitions between the first tinting level and the second tinting level based on when the user wants a more tinted display (e.g., while squinting). For example, the electronic device automatically transitions the display(s) to the second tinting level based whether the one or more criteria are satisfied.

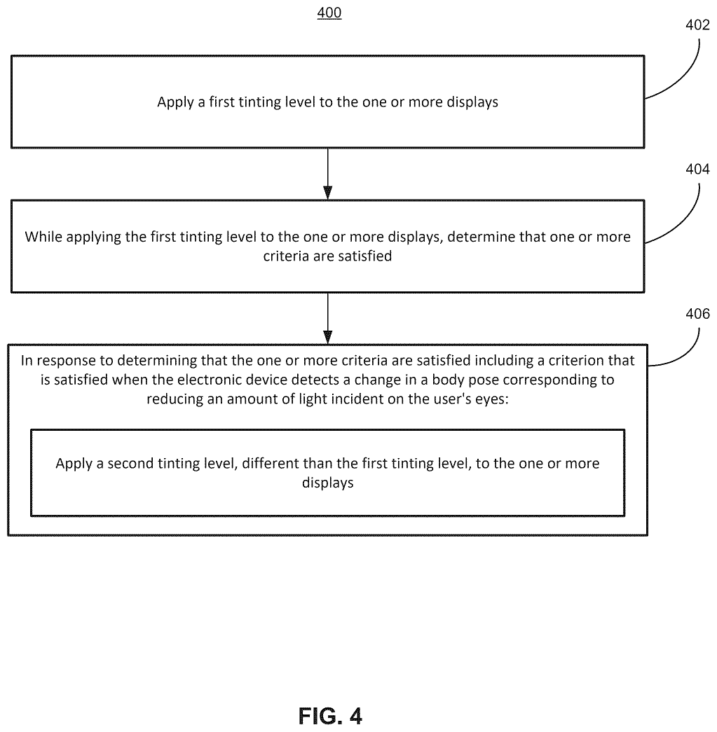

FIGS. 3A-3I illustrate examples of an electronic device changing tinting levels of displays and presenting content as a result of satisfying one or more criteria according to some examples of the disclosure. FIGS. 3A-3I are used to illustrate the methods described below, including process 400 in FIG. 4.

FIGS. 3A-3D illustrates examples of the electronic device changing the tinting level of the display(s) based determining that the one or more first criteria are satisfied. FIG. 3A illustrates an example of the user wearing the electronic device 101 while the display(s) 120a have a first tinting level 302. In some examples, electronic device 101 may be similar to electronic device 101 in FIG. 1, or electronic device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

In some examples, the display(s) 120a have the first tinting level 302 while the user is in a first physical environment. In some examples, the image sensors 206 (e.g., external image sensors 114b and 114c) captures images of the physical environment, which indicates that the user is indoors. For example, the external image sensors 114b and 114c are used to detect contextual signals indicating that the user is indoors (e.g., detecting furniture, walls, flooring, etc.). In some examples, the ambient sensor(s) 224 detects the amount of ambient light present in the first physical environment. For example, while indoors, the ambient sensor(s) 224 detects nominal lighting conditions. In some examples, the image sensors 206 (e.g., internal image sensors 114a) detects the characteristics (e.g., including size) of the eyes of the user. In some examples, while the user is indoors, the user is not squinting and the user's pupils are not constricted because the user's eyes are receiving nominal amount of light. In some examples, the electronic device 101 indirectly detects the size of the eyes of the user, while the user is wearing the electronic device 101. In FIG. 3A, the user is not squinting, and the one or more sensors (e.g., image sensors and ambient sensors) detects that the user is indoors with indoor ambient light (e.g., less than a threshold intensity of light, such as less than 10000 lux, less than 5000 lux, or less than 500 lux). As a result of these conditions (e.g., indoor with less than the threshold intensity of ambient light or light incident on the eyes), the electronic device 101 tints the displays 120a with the first tinting level 302. In some examples, the ambient light conditions and eye size while the user is determined to be indoors is used as a baseline for comparison of one or more criteria used for determining whether to apply the second tinting level to the displays 120a.

In some examples, applying the first tinting level 302 to the displays 120a includes applying a first opacity and/or a first brightness to the displays 120a (e.g., the lenses of the electronic device 101). In some examples, applying the first tinting level 302 includes allowing the user to view the first physical environment 304 (e.g., via passthrough video) with a first opacity and a first brightness. For example, the first tinting level 302 may include a brightness and opacity similar to conventional glasses, such as prescription glasses or reading glasses.

In some examples, the electronic device 101 changes the tinting level by adjusting the opacity of a dedicated layer of the display 120a. For example, the display 120a optionally includes a plurality of layers including a controllable tinting layer. In some examples, the controllable tinting layer is a frosted glass layer that can be controlled to present content with the first tinting level 302, the second tinting level 306, and/or other tinting levels as described herein. Alternatively, in some examples, the display 120a does not have a separate controllable tinting layer. For example, the tinting controls may be integrated into the display 120a (e.g., integrated in the other layers of display 120a). Alternatively, in some examples, the electronic device 101 may include a tintable layer that can be controlled to change from the first tinting level 302 to the second tinting level 306, and/or to other tinting levels, as described herein, without including the display 120a.

FIG. 3B illustrates an example of the user wearing the electronic device 101 while the display(s) 120a have a second tinting level 306. In some examples, the user moves from the first physical environment 304 (e.g., indoors) to the second physical environment 308 (e.g., outdoors). In some examples, moving to the second physical environment includes changing the characteristics of the first physical environment 304. For example, a user may remain in the same location but there may be a change in the first physical environment 304. For example, a new light source is introduced (e.g., the weather changes such that the clouds move, the rain clears, etc., and/or a light is reflected by a mirror or other surface). In some examples, the image sensors 206 and the ambient sensors 224 detect the change in physical environment including the transition from indoors to outdoors and the change in ambient light conditions (e.g., outdoor ambient light is greater than 10000 lux, greater than 5000 lux, or greater than 500 lux). Alternatively, or additionally, in some examples, the image sensors 206 and the ambient sensors 224 detect a change in physical environment due to a change in ambient light as a result of a change in light source. Furthermore, in some examples, the image sensors 206, specifically the internal image sensors 114a, detect that the user is squinting (e.g., detects movement corresponding to a change in size of a user's eyes). For example, the electronic device 101 determines that the user's eyes are greater than a threshold amount smaller than their baseline size (e.g., greater than 20% smaller, greater than 50% smaller, or greater than 75% smaller). In some examples, detecting that the user is squinting also includes determining a change in pupillary size (e.g., pupils are constricted), and/or a change in amount of light detected reflecting off of the eye (e.g., a decrease in the amount of light reflecting off of the eye as a result of a movement of the user's eyes to decrease the size of the user's eyes). As shown in FIG. 3B, the user is squinting as a result of the bright light from the sun, as a result of being outside. In some examples, after determining that the one or more first criteria are satisfied (e.g., the user is squinting because the ambient light has increased as a result of being outdoors and/or as a result of a change in light source), the electronic device 101 transitions the tinting level of the display(s) 120a from the first tinting level 302 to the second tinting level 306.

In some examples, applying the second tinting level 306 to the display(s) 120a includes applying a second brightness and/or second opacity to the lenses, different than the first brightness and the first opacity as described above. In some examples, the second brightness is lower than the first brightness and the second opacity is opaquer than the first opacity. In some examples, applying the second tinting level 306 reduces the amount of light incident on the user's eyes. In some examples, applying the second tinting level 306 includes allowing the user to view the second physical environment 308 (e.g., via passthrough video) with a second opacity and a second brightness, such that the user no longer has to squint. For example, the second tinting level 306 has the likeness of sunglasses or tinted lenses. In some examples, applying the second tinting level 306 to the display(s) 120a includes applying the second tinting level 306 gradually. For example, an intermediate tinting level (e.g., a tinting level that has a third brightness and/or third opacity that is between the first and second brightness and/or opacities) may be applied before applying the second tinting level 306. In some examples, the electronic device 101 has an iterative approach to changing the tinting levels from the first tinting level 302 to the second tinting level 306. For example, the electronic device 101 increases the tinting level (e.g., increases the opacity and/or decreases the brightness) of the display(s) 120a until the one or more first criteria are no longer satisfied (e.g., the user stops squinting because the level of tinting is enough, the user moves their hand from their face because the level of tinting is enough, and/or the user moves their head to a different position than the position shown in FIG. 3C).

In some examples, the electronic device 101 changes the tinting level by adjusting the opacity of a dedicated layer of the display 120a. For example, the display 120a optionally includes a plurality of layers including one or more controllable tinting layers, where each controllable tinting layer may be configured to filter an adjustable amount of light (e.g., light having a particular wavelength or range of wavelengths). In some examples, one of the controllable tinting layers may include a frosted glass layer that can be controlled to scatter an adjustable amount of incident light corresponding to the first tinting level 302, the second tinting level 306, and/or other tinting levels as described herein. Alternatively, in some examples, the display 120a does not have a separate controllable tinting layer. For example, the tinting controls may be integrated into the display 120a (e.g., integrated in the other layers of display 120a). Alternatively, in some examples, the electronic device 101 may include a tintable layer that can be controlled to change from the first tinting level 302 to the second tinting level 306, and/or to other tinting levels, as described herein, without the display 120a.

In some examples, the electronic device 101 includes hysteresis to prevent the display(s) 120a from constantly changing tinting levels as a result of a change in one or more factors that causes the one or more first criteria or the one or more second criteria (as described below) to be satisfied. For example, the electronic device 101 includes a time delay for transitioning between tinting levels such that the electronic device 101 can only transition tinting levels after a set amount of time since the previous change in tinting levels. The set amount of time may be 1 minute, 5 minutes, 15 minutes, or 30 minutes.

FIG. 3C-3D illustrate examples of other changes in body pose that optionally satisfy the one or more first criteria for the electronic device to apply the second tinting level 306 to the display(s) 120a. In FIG. 3C, the user is turning away from the source of light (e.g., the sun) while in the second physical environment 308. As a result, the electronic device 101 tints the displays 120a to make it easier for the user to see due to the source of light. In some examples, the electronic device 101 detects a change in body pose including a movement of the head that satisfies the one or more first criteria. For example, the one or more first criteria include a criterion that is satisfied when the electronic device 101 detects a movement of the electronic device greater than a threshold amount of movement. In some examples, the criterion is satisfied when the user remains in the post-movement body pose for greater than a threshold amount of time. In some examples, the threshold amount of movement is a movement of the electronic device 101 (and also the user's head) from a first position (e.g., before the change in body pose) to a second position (e.g., after the change in body pose). In some examples, the movement is a rotational movement of the electronic device 101, as a result of the user's head turning. In some examples, the threshold amount of movement may be 5 degrees, 10 degrees, 20 degrees, 30 degrees, 45 degrees, etc. of movement from the first position to the second position. In some examples, the electronic device 101 uses one or more sensors, such as an IMU sensor, described in FIG. 2, to detect movement that is greater than a threshold movement. Furthermore, the electronic device 101 detects that the user remains in the post-movement body pose for a threshold amount of time (e.g., 1 second, 5 seconds, 10 seconds, 30 seconds, or 1 minute). After detecting the movement for the threshold amount of time, the electronic device 101 updates the tinting levels of the displays 120a from the first tinting level to the second tinting level. In some examples, after updating the tinting level to the second tinting level 306, the user may return to their original position (e.g., before the movement greater than the threshold amount of movement) and the electronic device 101 remains tinted with the second tinting level 306.

FIG. 3D illustrates a different example of a change in body pose that results in the electronic device 101 updating the displays 120a from the first tinting level 302 to the second tinting level 306. In FIG. 3D, the user is shielding their eyes from the light source (e.g., the sun). For example, after the electronic device 101 detects a change in lighting conditions (e.g., the user goes outside in the sun, the user moves from a shaded area to a bright area, or the like), the electronic device 101 detects a change in body pose (e.g., the user moves their hand 310 or other object to their head to shield their eyes from the light source) for a threshold amount of time. In some examples, the threshold amount of time is described above in FIG. 3C. In some examples, the electronic device 101 uses image sensors 206 to determine that the user has moved their hand. In some examples, the electronic device 101 may be in communication with other electronic devices such as smart watches, phones, etc. In some examples, a different electronic device may transmit an indication to the electronic device 101 that the user has changed body poses (e.g., such as moving the position of their head or their hand 310 as described in FIGS. 3C-3D). In some examples, the electronic device 101 detects a localized reduction in lighting using the image sensors 206 and/or the ambient sensors 224 (e.g., caused by a user blocking light by changing body poses). The electronic device 101 may infer a change in body pose from the detection of a reduction in lighting. In some examples, the user may perform a plurality of changes to body pose that may indicate that the ambient light is too bright (e.g., squinting, moving their hands to shield the light, moving their head away from the light source, etc.), which results in the electronic device 101 changing the tinting level from the first tinting level 302 to the second tinting level 306. In some examples, the one or more first criteria may also include a criterion that is satisfied when the image sensors 206 detects an illumination of the user's eyes (e.g., using the internal image sensors) greater than a threshold level of illumination (e.g., greater than 10 lux, 50 lux, 100 lux, 1000 lux, or 5000 lux). For example, an illumination of the eye is when a light source is shining into the user's eye(s), making that portion of the user's face brighter. In some examples, illumination of the eye(s) may cause the user to squint or change their body pose to avoid the illumination of their eye(s).

In some examples, a change in body pose that meets the one or more first criteria (e.g., for a threshold amount of time and/or a threshold amount of movement) does not necessarily result in the electronic device 101 updating the displays 120a from the first tinting level 302 to the second tinting level 306. For example, if the electronic device 101 does not detect a change in environment (e.g., a change in ambient light, and/or a change in location) using the one or more sensors including the image sensors 206, the ambient sensors 224, and other sensors, then the electronic device 101 does not update the tinting level as a result of a change in body pose or squinting. For example, as shown in FIG. 3E, the user is squinting at their brightly lit phone 314 while in a dimly lit room (e.g., physical environment 312). In some examples, because the electronic device 101 detects that the physical environment has not changed, the electronic device 101 does not update the tinting level from the first tinting level 302 to the second tinting level 306. Additionally, and in some examples, the electronic device 101 detects that the act of looking at a display (e.g., of a phone, tablet, laptop, or other electronics) is a known activity where a transition from the first tinting level 302 to the second tinting level 306 is not necessary (e.g., not user preference). Additionally or alternatively, in some examples, the intensity of light from phone 314 is not sufficient to invoke a tinting response. For example, the intensity of light from phone 314 is significantly lower than the intensity of light from the sun (which causes the electronic device 101 to transition from the first tinting level 302 to the second tinting level 306). In some examples, a user may designate specific activities as “non-tinting activities,” wherein the electronic device 101 does not update the tinting level from the first tinting level 302 to the second tinting level 306. For example, the user may designate activities such as looking at a display, looking at a source of light while indoors, and other activities as non-tinting activities. In some examples, the electronic device 101 uses the image sensors 206 and the ambient sensors 224 to determine whether the light source is being used for a non-tinting activity. In some examples, in response to detecting squinting (or other changes in body pose) as a result of a bright display indoors, the electronic device 101 may update the tinting level from the first tinting level to a third tinting level. In some examples, the third tinting level is a blue light filter.

In some examples, in response to detecting squinting (or other changes in body pose) as a result of a bright display indoors, the electronic device 101 may transmit an indication to dim the display to the electronic device associated with the display. In some examples, the electronic device associated with the display and the electronic device 101 are in communication with each other (e.g., wireless or wired communication). In some examples, the electronic device associated with the display and the electronic device 101 are associated with the same user account and/or have the same hardware and/or source code manufacturer.

In some examples, the user may want to resume viewing the physical environment through the display(s) 120a with the first tinting level 302. For example, the user leaves physical environment 308, shown in FIG. 3C and returns to physical environment 304, shown in FIG. 3A. In response to returning to the physical environment 304, the electronic device 101 ceases applying the second tinting level 306 and begins applying the first tinting level 302. In some examples, while applying the second tinting level 306, the electronic device 101 determines that one or more second criteria are satisfied. In response to determining that the one or more second criteria are satisfied, the electronic device 101 ceases applying the second tinting level 306 and applies the first tinting level 302. In some examples, the electronic device 101 applies a fourth tinting level in response to determining that the one or more second criteria are satisfied, different than the first, second, and third tinting levels.

In some examples, the one or more second criteria include a criterion that is satisfied when the one or more first criteria (e.g., a change in body pose and/or squinting), or a subset of the one or more first criteria are not satisfied. In some examples, the user may move physical locations such that the ambient light is not bright enough to warrant the second tinting level 306 (or the third tinting level). For example, the user may move physical locations (e.g., from physical environment 308 to physical environment 304) such that they move from outdoors to indoors. As a result, the electronic device 101 applies the first tinting level 302. In some examples, the user may remove the source of the bright light (e.g., turning off the bright display) which causes the user to no longer squint. As a result, the electronic device 101 transitions the display(s) 120a from the third tinting level or second tinting level 306 to the first tinting level 302. In some examples, the one or more second criteria include a criterion that is satisfied based on pupil dilation (e.g., the pupils are more dilated as a result of less ambient light). In some examples, the electronic device 101 passively tracks pupil size using the one or more sensors including the image sensors 206. In some examples, while the user is squinting and/or changing their body pose due to the relatively high ambient light level, the user's pupils are constricted. In some examples, in response to removing the one or more stimuli, and therefore indicating that the electronic device 101 should transition the display(s) 120a from the second tinting level 306 to the first tinting level 302, the user's pupils are more dilated. In some examples, the electronic device 101 transitions the display(s) 120a from the third tinting level or second tinting level 306 to the first tinting level 302 after detecting that the pupils are 1%, 10%, 20%, 50%, or 75% more dilated.

FIGS. 3F-3G illustrates an electronic device 101 presenting, via the display(s) 120a, a three-dimensional environment 318 from a point of view of the user of the electronic device 101 (e.g., facing a tree 322 in an outdoor environment in which electronic device 101 is located, as shown in FIG. 3F). In some examples, the three-dimensional environment 318 is a see-through environment of the physical environment. For example, the displays on electronic device 101 are transparent and a user can see the physical environment through the displays. In some examples, a different electronic device in communication with the electronic device 101 causes the electronic device 101 to present the three-dimensional environment 318. In some examples, a viewpoint of a user determines what content (e.g., physical objects and/or virtual objects) is visible in a viewport (e.g., a view of the three-dimensional environment 318 visible to the user via one or more display(s) 120a, a display or a pair of display modules that provide stereoscopic content to different eyes of the same user, or through the optical see-through device). In some examples, the (virtual) viewport has a viewport boundary that defines an extent of the three-dimensional environment 318 that is visible to the user via the displays 120a in FIGS. 3F-3G. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user determines what content (e.g., physical content and/or virtual content) is visible in the viewport. A viewpoint generally specifies a location and a direction relative to the three-dimensional environment, and as the viewpoint shifts, the view of the three-dimensional environment will also shift in the viewport. For a head mounted device, a viewpoint is typically based on a location, a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see-through, portions of the physical environment that are visible (e.g., optically visible through one or more partially or fully transparent portions of the display generation component) via the one or more displays are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 3F, the electronic device 101 includes a display 120a and a plurality of sensors as described above and controlled by the electronic device 101 to display one or more user interfaces while presenting true or real optical see-through in which portions of the physical environment are visible to the user through a transparent portion of the display while the user interacts with the electronic device 101 and/or with the physical world. FIGS. 3F-3G illustrate an optical see-through environment that is presented to the user by electronic device 101.

As shown in FIG. 3F, the electronic device 101 displays a user interface 316 of an application in the three-dimensional environment 318 (showing the physical environment 308 through the optical see-through) accompanied with a first tinting level 302. In some examples, while the electronic device 101 is displaying user interface 316, the display 120a of the electronic device 101 appears with a first tinting level 302 while the user is wearing the electronic device 101 and before the one or more first criteria are satisfied. For example, the lens(es) of the electronic device 101 may be tinted with the first tinting level 302 such that other people looking at the electronic device 101 can see the first tinting level 302.

It should be understood that, in some examples, the electronic device 101 displays a user interface different from user interface 316 or a plurality of user interfaces (e.g., including or different from the user interface 316) associated with a plurality of different applications while concurrently presenting the three-dimensional environment 318 with the first tinting level 302. In some examples, the electronic device 101 may display the same tinting characteristics as shown in FIG. 3A while the user is alternatively viewing and/or interacting with other user interfaces, such as, but not limited to, content user interfaces (e.g., web browsing user interfaces, video chatting user interfaces, video player user interfaces, music user interfaces, gaming user interfaces, and/or social media user interfaces). In some examples, a user of electronic device 101 may (e.g., manually or with verbal command) determine the applications and/or user interfaces to display while the three-dimensional environment 318 is presented with the first tinting level 302.

FIG. 3G illustrates the three-dimensional environment 318 after the one or more first criteria are satisfied. FIG. 3G illustrates an example of what the user sees through electronic device 101 in response to the actions described in FIG. 3D. In some examples, and as described above, after the one or more first criteria are satisfied, the electronic device 101 ceases applying the first tinting level 302 to the display(s) 120a and begins applying the second tinting level 306 to the display(s) 120a. For example, the lens(es) of the electronic device 101 may be tinted with the second tinting level 306 such that other people looking at the electronic device 101 can see the second tinting level 306. As shown in FIG. 3G, in response to detecting a change in body pose (e.g., shielding the sun with a hand 310), which satisfy the one or more first criteria, the electronic device 101 presents the three-dimensional environment 318 (showing the physical environment 308 through the optical see-through) with the second tinting level 306. In some examples, and as shown in FIG. 3G, the electronic device 101 does not change the presentation of virtual content (e.g., user interface 316) while applying the second tinting level 306. For example, the electronic device 101 does not display the user interface 316 with the second tinting level 306, while displaying the optical see-through or pass-through display of the physical environment with the second tinting level 306. Alternatively, in some examples, the electronic device 101 displays the user interfaces with the second tinting level 306.

In some examples, movement of the user's eyes (e.g., squinting) does not correspond to a request to tint the display(s) 120a. For example, and as shown in FIGS. 3H-3I, squinting may indicate that the user may need corrective lenses (or a stronger prescription for their corrective lenses). In some examples, the electronic device 101 may determine that one or more third criteria are satisfied. In some examples, in response to determining that the one or more third criteria are satisfied, the electronic device 101 may display a visual indication indicating that the user may need an updated vision prescription or may need to schedule an appointment for an eye exam. In some examples, the one or more third criteria include detecting a movement of the eyes that satisfied the one or more first criteria (e.g., squinting), as described above, without detecting a change in physical environment (e.g., without detecting that the user has moved from a dim area to a bright area such as moving from indoors to outdoors and/or without detecting a light source/intensity of light that causes squinting). Additionally or alternatively, in some examples, the one or more third criteria include a criterion that is satisfied when the electronic device 101 detects words in the viewport of the electronic device 101 (e.g., indicating that the user is reading). Satisfying the one or more third criteria may indicate that the user is squinting when squinting is not the result of a change in ambient light and/or a light that is too bright. As shown in FIG. 3H, the user is in physical environment 324, which is an indoor area with a board 328, including words. The user is wearing the electronic device 101 and the display(s) 120a have the first tinting level 302 applied. In FIG. 3H, the user is squinting to look at the words on board 328. While the user is squinting, the electronic device 101 does not detect a change in ambient light or an illumination of the user's eyes from a light source, therefore the electronic device 101 does not apply the second tinting level 306 to the display(s) 120a. Instead, the electronic device 101 presents visual indication 326 in the three-dimensional environment 330 (while showing physical environment 324). In some examples, the visual indication 326 includes text and/or images suggesting to the user to get an updated vision prescription and/or to see an eye care professional (e.g., an optometrist). In some examples, the visual indication 326 is presented at a different time (e.g., after the user is finished reading board 328 and/or after a time delay, such as after 10 seconds, 30 seconds, 1 minute, 5 minutes, 30 minutes, or 1 hour from detecting that the one or more third criteria are satisfied). In some examples, the visual indication 326 is presented on a different device in communication with electronic device 101 (e.g., on a smart phone, smart watch, tablet, and/or computer).

FIG. 4 illustrates a flow diagram illustrating an example process for an electronic device changing tinting levels of lenses or displays and presenting content as a result of satisfying one or more criteria according to some examples of the disclosure. In some examples, process 400 begins at an electronic device in communication with one or more displays and one or more input devices. In some examples, the electronic device is optionally a head-mounted display similar or corresponding to electronic device 201 of FIG. 2A or a mobile electronic device similar or corresponding to electronic device 260 of FIG. 2B. As shown in FIG. 4, in some examples, at 402, the electronic device applies a first tinting level to the one or more displays. For example, the electronic device (e.g., electronic device 101 in FIG. 3A) applies a first tinting level 302 to the one or more displays (e.g., display(s) 120a) before the one or more first criteria are satisfied.

In some examples, at 404, while applying the first tinting level to the one or more displays, determining that one or more criteria are satisfied. For example, the electronic device detects a change in body pose, such as a movement of a hand and/or arm, to shield a source of light (as described in FIG. 3D), a movement of the eyes (e.g., squinting as described in FIG. 3B), and/or a movement of a head (as described in FIG. 3C).

In some examples, at 406, the electronic device applies a second tinting level (e.g., second tinting level 306 as shown in FIGS. 3B-3D), different that the first tinting level, to the one or more displays in response to determining that the one or more criteria are satisfied including a criterion that is satisfied when the electronic device detects a change in body pose corresponding to reducing an amount of light incident on the user's eyes. In some examples, applying the second tinting level 306 helps block light to the user's eyes, therefore reducing the amount of light incident on the user's eyes. In some examples, the electronic device 101 may apply a third tinting level, described in FIG. 3E, when detecting that the one or more second criteria are satisfied.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising at an electronic device in communication with one or more controllable tinting layers and one or more input devices including an optical sensor: applying a first tinting level to the one or more controllable tinting layers; while applying the first tinting level to the one or more controllable tinting layers, determining that one or more criteria are satisfied; and in response to determining that the one or more criteria are satisfied including a criterion that is satisfied when the electronic device detects a change in a body pose corresponding to reducing an amount of light incident on one or more eyes of a user: applying a second tinting level, different than the first tinting level, to the one or more controllable tinting layers. Additionally or alternatively to one of more of the examples disclosed above, in some examples, detecting the change in the body pose includes detecting a movement of one or more extremities. Additionally or alternatively to one of more of the examples disclosed above, in some examples, detecting the change in the body pose includes detecting a movement of one or more eyes. Additionally or alternatively to one of more of the examples disclosed above, in some examples, detecting the change in the body pose includes detecting a movement of a head. Additionally or alternatively to one of more of the examples disclosed above, in some examples, detecting a change in body pose further includes detecting the change in the body pose for an amount of time greater than a threshold amount of time. Additionally or alternatively to one of more of the examples disclosed above, in some examples, the one or more criteria includes a criterion that is satisfied when the electronic device detects a movement of the electronic device greater than a threshold amount of movement. Additionally or alternatively to one of more of the examples disclosed above, in some examples, the one or more criteria includes a criterion that is satisfied when the electronic device detects a movement of the electronic device greater than a threshold amount of movement away from a light source. Additionally or alternatively to one of more of the examples disclosed above, in some examples, the optical sensor is an inward facing camera; and the one or more criteria includes a criterion that is satisfied when the electronic device detects an illumination of an eye greater than a threshold level of illumination. Additionally or alternatively to one of more of the examples disclosed above, in some examples, the one or more input devices further comprises an ambient light sensor configured to detect a contextual change of ambient light conditions. Additionally or alternatively to one of more of the examples disclosed above, in some examples, the electronic device is further in communication with one or more displays, and wherein the second tinting level is applied to the one or more controllable tinting layers without changing the presentation of virtual content on the one or more displays. Additionally or alternatively to one of more of the examples disclosed above, in some examples, the electronic device is further in communication with one or more displays, and wherein the second tinting level is applied to the one or more controllable tinting layers while changing the presentation of virtual content on the one or more displays. Additionally or alternatively to one of more of the examples disclosed above, in some examples, determining that one or more second criteria are satisfied including a criterion that is satisfied when the electronic device detects a movement of one or more eyes that satisfies the one or more criteria without detecting a contextual change of an ambient light condition; and in response to determining that the one or more second criteria are satisfied: presenting a visual indication on one or more displays in communication with the electronic device. Additionally or alternatively to one of more of the examples disclosed above, in some examples, while applying the second tinting level to the one or more controllable tinting layers, determining that one or more third criteria are satisfied; and in response to determining that the one or more third criteria are satisfied, applying a third tinting level to the one or more controllable tinting layers.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more controllable tinting layers and one or more input devices including an optical sensor:
applying a first tinting level to the one or more controllable tinting layers;
while applying the first tinting level to the one or more controllable tinting layers, determining that one or more criteria are satisfied; and
in response to determining that the one or more criteria are satisfied including a criterion that is satisfied when the electronic device detects a change in a body pose corresponding to reducing an amount of light incident on one or more eyes of a user:
applying a second tinting level, different than the first tinting level, to the one or more controllable tinting layers.

2. The method of claim 1, wherein detecting the change in the body pose includes detecting at least one of:
a movement of one or more extremities;
a movement of one or more eyes;
a movement of a head; or
the change in the body pose for an amount of time greater than a threshold amount of time.

3. The method of claim 1, wherein the one or more criteria includes at least one of:
a criterion that is satisfied when the electronic device detects a movement of the electronic device greater than a threshold amount of movement; or
a criterion that is satisfied when the electronic device detects a movement of the electronic device greater than a threshold amount of movement away from a light source.

4. The method of claim 1, wherein the optical sensor is an inward facing camera; and
the one or more criteria includes a criterion that is satisfied when the electronic device detects an illumination of an eye greater than a threshold level of illumination.

5. The method of claim 1, wherein the electronic device is further in communication with one or more displays, and wherein the second tinting level is applied to the one or more controllable tinting layers without changing a presentation of virtual content on the one or more displays.

6. The method of claim 1, wherein the electronic device is further in communication with one or more displays, and wherein the second tinting level is applied to the one or more controllable tinting layers while changing a presentation of virtual content on the one or more displays.

7. The method of claim 1, further comprising:
determining that one or more second criteria are satisfied including a criterion that is satisfied when the electronic device detects a movement of one or more eyes that satisfies the one or more criteria without detecting a contextual change of an ambient light condition; and
in response to determining that the one or more second criteria are satisfied:
presenting a visual indication on one or more displays in communication with the electronic device.

8. The method of claim 1, further comprising:
while applying the second tinting level to the one or more controllable tinting layers, determining that one or more third criteria are satisfied; and
in response to determining that the one or more third criteria are satisfied, applying a third tinting level to the one or more controllable tinting layers.

9. An electronic device comprising:
one or more displays;
one or more controllable tinting layers;
a memory;
one or more input devices including an optical sensor;
one or more processors; and
one or more programs stored in the memory and configured to be executed by the one or more processors, the one or more programs including instructions for:
applying a first tinting level to the one or more displays;
while applying the first tinting level to the one or more displays, determining that one or more criteria are satisfied; and
in response to determining that the one or more criteria are satisfied including a criterion that is satisfied when the electronic device detects a change in a body pose corresponding to reducing an amount of light incident on one or more eyes of a user:
applying a second tinting level, different than the first tinting level, to the one or more displays.

10. The electronic device of claim 9, wherein detecting the change in the body pose includes at least one of:
detecting a movement of one or more extremities;
detecting a movement of one or more eyes;
detecting a movement of a head; or
detecting the change in the body pose for an amount of time greater than a threshold amount of time.

11. The electronic device of claim 9, wherein the one or more criteria includes a criterion that is satisfied when the electronic device detects at least one of:
a movement of the electronic device greater than a threshold amount of movement; or
a criterion that is satisfied when the electronic device detects a movement of the electronic device greater than a threshold amount of movement away from a light source.

12. The electronic device of claim 9, wherein the optical sensor is an inward facing camera; and
the one or more criteria includes a criterion that is satisfied when the electronic device detects an illumination of an eye greater than a threshold level of illumination.

13. The electronic device of claim 9, wherein the electronic device is further in communication with one or more displays, and wherein the second tinting level is applied to the one or more controllable tinting layers without changing a presentation of virtual content on the one or more displays.

14. The electronic device of claim 9, wherein the electronic device is further in communication with one or more displays, and wherein the second tinting level is applied to the one or more controllable tinting layers while changing a presentation of virtual content on the one or more displays.

15. The electronic device of claim 9, the one or more programs further including instructions for:
determining that one or more second criteria are satisfied including a criterion that is satisfied when the electronic device detects a movement of one or more eyes that satisfies the one or more criteria without detecting a contextual change of an ambient light condition; and
in response to determining that the one or more second criteria are satisfied:
presenting a visual indication on one or more displays in communication with the electronic device.

16. The electronic device of claim 9, the one or more programs further including instructions for:
while applying the second tinting level to the one or more controllable tinting layers, determining that one or more third criteria are satisfied; and
in response to determining that the one or more third criteria are satisfied, applying a third tinting level to the one or more controllable tinting layers.

17. A non-transitory computer readable storage medium storing one or more programs, the one or more programs comprising instructions, which when executed by one or more processors of an electronic device including one or more controllable tinting layers and one or more input devices including an optical sensor, cause the electronic device to perform a method comprising:
applying a first tinting level to one or more displays;
while applying the first tinting level to the one or more displays, determining that one or more criteria are satisfied; and
in response to determining that the one or more criteria are satisfied including a criterion that is satisfied when the electronic device detects a change in a body pose corresponding to reducing an amount of light incident on one or more eyes of a user:
applying a second tinting level, different than the first tinting level, to the one or more displays.

18. The non-transitory computer readable storage medium of claim 17, wherein detecting the change in the body pose includes at least one of:
detecting a movement of one or more extremities;
detecting a movement of one or more eyes;
detecting a movement of a head; or
detecting the change in the body pose for an amount of time greater than a threshold amount of time.

19. The non-transitory computer readable storage medium of claim 17, wherein the one or more criteria includes at one of:
a criterion that is satisfied when the electronic device detects a movement of the electronic device greater than a threshold amount of movement; or
a criterion that is satisfied when the electronic device detects a movement of the electronic device greater than a threshold amount of movement away from a light source.

20. The non-transitory computer readable storage medium of claim 17, wherein the optical sensor is an inward facing camera; and
the one or more criteria includes a criterion that is satisfied when the electronic device detects an illumination of an eye greater than a threshold level of illumination.

21. The non-transitory computer readable storage medium of claim 17, wherein the electronic device is further in communication with one or more displays, and wherein the second tinting level is applied to the one or more controllable tinting layers without changing a presentation of virtual content on the one or more displays.

22. The non-transitory computer readable storage medium of claim 17, wherein the electronic device is further in communication with one or more displays, and wherein the second tinting level is applied to the one or more controllable tinting layers while changing a presentation of virtual content on the one or more displays.

23. The non-transitory computer readable storage medium of claim 17, the method further comprising:
determining that one or more second criteria are satisfied including a criterion that is satisfied when the electronic device detects a movement of one or more eyes that satisfies the one or more criteria without detecting a contextual change of an ambient light condition; and
in response to determining that the one or more second criteria are satisfied:
presenting a visual indication on one or more displays in communication with the electronic device.

24. The non-transitory computer readable storage medium of claim 17, the method further comprising:
while applying the second tinting level to the one or more controllable tinting layers, determining that one or more third criteria are satisfied; and
in response to determining that the one or more third criteria are satisfied, applying a third tinting level to the one or more controllable tinting layers.
